(19) United States
(12) Patent Application Publication
(10) Pub. No.: US 2019/0360831 A1
(43) Pub. Date: Nov. 28, 2019

(54) AUTOMATIC DRIVING METHOD AND DEVICE

(71) Applicants: Neusoft Corporation, Shenyang (CN); Neusoft Reach Automotive Technology (Shanghai) Co. Ltd., Shanghai (CN)

(72) Inventors: Wei LIU, Shenyang (CN); Wei LIU, Shenyang (CN)

(21) Appl. No.: 16/100,227

(22) Filed: Aug. 10, 2018

(30) Foreign Application Priority Data
May 25, 2018 (CN) 201810516041.4

(51) Int. Cl. G01C 21/34; G05D 1/02; G05D 1/00; G08G 1/0968

(52) U.S. Cl. CPC G01C 21/3484; G08G 1/096888; G05D 1/0088; G05D 1/0221

(57) ABSTRACT

An automatic driving method and an automatic driving device are provided. The method includes: determining whether a target vehicle travels on a pre-defined commuting route, where the commuting route is a fixed route on which the target vehicle travels at a frequency higher than a predetermined frequency threshold; acquiring target travel information corresponding to the commuting route if the target vehicle travels on the pre-defined commuting route, where the target travel information includes a historical running trajectory of the target vehicle on the commuting route; and controlling the target vehicle to perform automatic drive on the commuting route based on the target travel information.

### CROSS REFERENCE OF RELATED APPLICATION

The present application claims priority to Chinese Patent Application No. 201810516041.4, titled “AUTOMATIC DRIVING METHOD AND DEVICE”, filed on May 25, 2018 with the state intellectual property office of People's Republic of China, which is incorporated herein by reference in its entirety.

### FIELD

The present disclosure relates to the technical field of vehicle, and in particular to an automatic driving method and an automatic driving device.

### BACKGROUND

In daily driving, a driver may frequently drive a vehicle on a fixed route. For example, if the driver is an employee, he may usually drive a car on roads to and from the work, which form a fixed route. For another example, if a driver usually drives a car to a nearby shopping mall or supermarket for shopping, the roads between his house and the shopping place form a fixed route. The driver may feel tired due to repeated and tedious driving actions since he drives the vehicle on these fixed routes repeatedly for a long time, thereby affecting the driving experience.

When driving on the fixed route, the driver has to continuously pay attention to the real-time changes on the route, so as to control the vehicle better. At present, a high-precision map is often used to assist the driver. However, the application of the high-precision map also has many limitations. For example, since the high-precision map is a map including all routes, it contains a large amount of data, which is unfavorable for local storage. In addition, since the road facilities are changed quickly, the high-precision map may not meet actual requirements of driving on a fixed route. Moreover, since the route frequently used by the driver is a fixed route, most data of the high-precision map is useless but requires a large storage. Furthermore, in some countries and regions, the high-precision map may be restricted by laws and regulations to have a low resolution. Moreover, a navigation route calculated by a navigation system may deviate from an actual route.

### SUMMARY

An automatic driving method and an automatic driving device are provided according to embodiments of the present disclosure, with which a vehicle can be controlled to perform automatic drive on a fixed route, so as to improve the driving experience.

An automatic driving method is provided according to an embodiment of the present disclosure. The method includes: determining whether a target vehicle travels on a pre-defined commuting route, where the commuting route is a fixed route on which the target vehicle travels at a frequency higher than a predetermined frequency threshold; acquiring target travel information corresponding to the commuting route if the target vehicle travels on the pre-defined commuting route, where the target travel information includes a historical running trajectory of the target vehicle on the commuting route; and controlling the target vehicle to perform automatic drive on the commuting route based on the target travel information.

In an embodiment, the determining whether a target vehicle travels on a pre-defined commuting route includes: acquiring current position information of the target vehicle; and determining whether the target vehicle travels on the pre-defined commuting route based on the current position information and a forward direction of the target vehicle.

In an embodiment, the controlling the target vehicle to perform automatic drive on the commuting route based on the target travel information includes: determining one or more available lanes of the commuting route based on the historical running trajectory; and selecting one of the available lanes or selecting different ones of the available lanes successively, during a process that the target vehicle is controlled to perform automatic drive.

In an embodiment, the target travel information further includes at least one of:

running state information of the target vehicle in the historical running trajectory; and information on a control behavior performed by the driver on the target vehicle in the historical running trajectory.

In an embodiment, the target travel information includes running state information of the target vehicle in the historical running trajectory, and the controlling the target vehicle to perform automatic drive on the commuting route based on the target travel information includes: generating trajectory information based on the running state information, where the trajectory information includes one or more of: curvature information of position points in the historical running trajectory, speed limit information of at least one position point in the historical running trajectory, and reference range information of steering wheel angles at the position points in the historical running trajectory; and controlling the target vehicle to perform automatic drive on the commuting route based on the target travel information and the trajectory information.

In an embodiment, the commuting route is defined by: recording vehicle position information of the target vehicle at recording time points during a process that the target vehicle travels from a target start point to a target end point, where the target start point is an origin set for the commuting route by a driver, and the target end point is a destination set for the commuting route by the driver; forming a running trajectory of the target vehicle with the recorded vehicle position information; and defining a road consistent with the running trajectory as the commuting route.

In an embodiment, the commuting route is defined by: recording vehicle position information of the target vehicle at recording time points during a running of the target vehicle; forming a running trajectory of the target vehicle with the recorded vehicle position information; determining whether the number of times that the target vehicle runs on a road consistent with the running trajectory exceeds a preset threshold within a preset period of time; and defining the road as the commuting route if the number of times that the target vehicle runs on the road consistent with the running trajectory exceeds the preset threshold within the preset period of time.

In an embodiment, the recording vehicle position information of the target vehicle at recording time points includes: recording geodetic coordinates of the target vehicle at the recording time points; or recording local coordinates of the target vehicle at the recording time points.

An automatic driving device is provided according to an embodiment of the present disclosure. The device includes: a determining device, configured to determine whether a target vehicle travels on a pre-defined commuting route, where the commuting route is a fixed route on which the target vehicle travels at a frequency higher than a predetermined frequency threshold; an acquisition device, configured to acquire target travel information corresponding to the commuting route if the target vehicle travels on the pre-defined commuting route, where the target travel information includes a historical running trajectory of the target vehicle on the commuting route; and a control device, configured to control the target vehicle to perform automatic drive on the commuting route based on the target travel information.

In an embodiment, the determining device includes: an information acquisition subdevice, configured to acquire current position information of the target vehicle; and a route determining subdevice, configured to determine whether the target vehicle travels on the pre-defined commuting route based on the current position information and a forward direction of the target vehicle.

In an embodiment, the control device includes: a determination subdevice, configured to determine one or more available lanes of the commuting route based on the historical running trajectory; and a selection subdevice, configured to select one of the available lanes or select different ones of the available lanes successively, during the automatic drive of the target vehicle.

In an embodiment, the target travel information further includes at least one of: running state information of the target vehicle in the historical running trajectory; and information on a control behavior performed by the driver on the target vehicle in the historical running trajectory.

In an embodiment, the target travel information comprises running state information of the target vehicle in the historical running trajectory, and the control device includes: a generation subdevice, configured to generate trajectory information based on the running state information, where the trajectory information includes one or more of: curvature information of position points in the historical running trajectory, speed limit information of at least one position point in the historical running trajectory, and reference range information of steering wheel angles at the position points in the historical running trajectory; and a control subdevice, configured to control the target vehicle to perform automatic drive on the commuting route based on the target travel information and the trajectory information.

In an embodiment, the device further includes: a recording device, configured to record vehicle position information of the target vehicle at recording time points during a process that the target vehicle travels from a target start point to a target end point, where the target start point is an origin set for the commuting route by a driver, and the target end point is a destination set for the commuting route by the driver; a forming device, configured to form a running trajectory of the target vehicle with the recorded vehicle position information; and a defining device, configured to define a road consistent with the running trajectory as the commuting route.

In an embodiment, the device further includes: a recording device, configured to record vehicle position information of the target vehicle at recording time points during a running of the target vehicle; a forming device, configured to form a running trajectory of the target vehicle with the recorded vehicle position information; a determining device, configured to determine whether the number of times that the target vehicle runs on a road consistent with the running trajectory exceeds a preset threshold within a preset period of time; and a defining device, configured to define the road as the commuting route if the number of times that the target vehicle runs on the road consistent with the running trajectory exceeds the preset threshold within the preset period of time.

In an embodiment, the recording device is configured to record geodetic coordinates of the target vehicle at the recording time points; or record local coordinates of the target vehicle at the recording time points.

An automatic driving device is further provided according to an embodiment of the present disclosure. The device includes a processor, a memory and a system bus.

The processor and the memory are connected to each other via the system bus.

The memory is configured to store one or more programs including instructions. The instructions, when executed by the processor, cause the processer to perform the method according to any one of the above embodiments.

A computer readable storage medium is further provided according to an embodiment of the present disclosure. The computer readable storage medium stores instructions. The instructions, when running on a terminal device, cause the terminal device to perform the method according to any one of the above embodiments.

A computer program product is further provided according to an embodiment of the present disclosure. The computer program product, when running on a terminal device, causes the terminal device to perform the method according to any one of the above embodiments.

In the automatic driving method and automatic driving device provided according to the embodiments of the present disclosure, it is determined whether a target vehicle travels on a pre-defined commuting route, where the commuting route is a fixed route on which the target vehicle travels at a frequency higher than a predetermined frequency threshold. Target travel information corresponding to the commuting route is acquired if the target vehicle travels on the pre-defined commuting route. The target travel information includes a historical running trajectory of the target vehicle on the commuting route. The target vehicle is controlled to perform automatic drive on the commuting route based on the target travel information. Therefore, with the embodiments of the present disclosure, the target vehicle, instead of being manually controlled by a driver to travel on the commuting route, can be controlled to perform automatic drive on the commuting route based on the acquired target travel information corresponding to the commuting route. Hence, repeated and tedious driving actions performed by the driver are reduced, thereby improving the driving experience of the driver.

### BRIEF DESCRIPTION OF THE DRAWINGS

The drawings to be used in the description of the embodiments will be described briefly as follows, so that the technical solutions according to the embodiments of the present disclosure will become clearer. It is apparent that the drawings in the following description only illustrate some embodiments of the present disclosure.

FIG. 1 is a first flowchart of an automatic driving method according to an embodiment of the present disclosure;

FIG. 2 is a second flowchart of an automatic driving method according to an embodiment of the present disclosure;

FIG. 3 is a schematic diagram of a rear axle center of a vehicle according to an embodiment of the present disclosure;

FIG. 4 is a third flowchart of an automatic driving method according to an embodiment of the present disclosure;

FIG. 5 is a schematic diagram of available lanes on a commuting route according to an embodiment of the present disclosure;

FIG. 6 is a schematic diagram of a running trajectory on a commuting route according to an embodiment of the present disclosure;

FIG. 7 is a fourth flowchart of an automatic driving method according to an embodiment of the present disclosure;

FIG. 8 is a schematic diagram showing a commuting route redefining process according to an embodiment of the present disclosure;

FIG. 9A is a first block diagram of a structure of an automatic driving device according to an embodiment of the present disclosure;

FIG. 9B is a second block diagram of a structure of an automatic driving device according to an embodiment of the present disclosure;

FIG. 9C is a third block diagram of a structure of an automatic driving device according to an embodiment of the present disclosure;

FIG. 9D is a fourth block diagram of a structure of an automatic driving device according to an embodiment of the present disclosure; and

FIG. 10 is a schematic structural diagram of an automatic driving device according to an embodiment of the present disclosure.

### DETAILED DESCRIPTION OF EMBODIMENTS

An automatic driving method and an automatic driving device are provided according to the present disclosure. With the method and device, without using a high-precision map to assist the driver, a vehicle is controlled to perform automatic drive on a fixed route based on historical running trajectory of the driver on the fixed route. In this way, it is unnecessary for the driver to manually control the vehicle to travel on the fixed route, thereby reducing the repeated and tedious driving actions performed by the driver and improving the driving experience of the driver. The method is described in detail below.

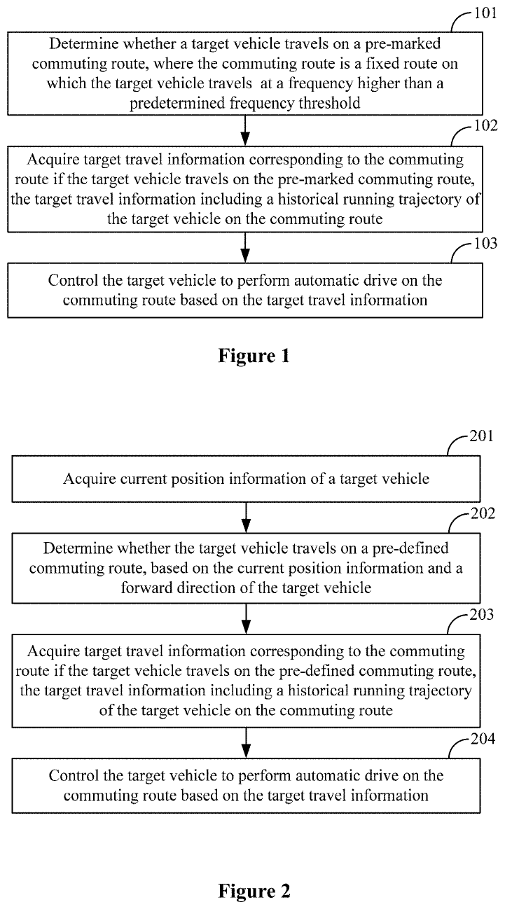

Reference is made to FIG. 1, which shows a flowchart of an automatic driving method according to an embodiment of the present disclosure. As shown in FIG. 1, the method includes steps 101 to 103.

In step 101, it is determined whether a target vehicle travels on a pre-defined commuting route, where the commuting route is a fixed route on which the target vehicle travels at a frequency higher than a predetermined frequency threshold.

In practices, any vehicle which adopts the automatic driving method according to the embodiment is defined as a target vehicle. It may be determined whether the target vehicle travels on the pre-defined commuting route.

The commuting route indicates a fixed route on which the target vehicle travels at a frequency higher than a predetermined frequency threshold. For example, the commuting route may be a fixed road on which an enterprise driver drives the scheduled bus to transfer the employees to and from the work, a road on which an employee drives the vehicle to and from the work, or the like. The frequent travel indicates that the target vehicle travels on a same route at least twice in a preset period of time. For example, if the target vehicle travels on a same route at least twice in a week, this route is a frequent-travel route for the target vehicle. It should be noted that, although the roads to and from the work are the same, the road to the work and the road from the work form two different commuting routes since the vehicle travels in different directions on the roads.

The pre-defined commuting route is a commuting route which is defined in advance. Information on the commuting route may be stored in a local database of the target vehicle or stored in a cloud database at a server side capable of communicating with the target vehicle. In this case, when an automatic driving function of the target vehicle is activated, it can be determined whether the target vehicle travels on the commuting route based on information in the local database or the cloud database. Then, step 102 is performed.

In step 102, target travel information corresponding to the commuting route is acquired if the target vehicle travels on the pre-defined commuting route. The target travel information includes a historical running trajectory of the target vehicle on the commuting route.

In practices, if it is determined in step 101 that the target vehicle travels on the pre-defined commuting route, target travel information corresponding to the commuting route may be further acquired. The target travel information includes a historical running trajectory of the target vehicle on the commuting route.

The historical running trajectory is a trajectory of a historical travel of the target vehicle on the commuting route, and is stored in the above local database or cloud database. Since two different commuting routes may be formed due to different travel directions in a same road, the target vehicle has different travel trajectories on the different commuting routes and the travel trajectories correspond to different target travel information.

In step 103, the target vehicle is controlled to perform automatic drive on the commuting route based on the target travel information.

It should be noted that, the automatic driving function of the target vehicle can be activated at any time before step 103 is performed.

In an implementation, after the target travel information corresponding to the commuting route is acquired in step 102, that is, after the historical running trajectory of the target vehicle on the commuting route is acquired, the target vehicle can be controlled to perform automatic drive on the commuting route based on the historical running trajectory of the target vehicle on the commuting route if the automatic travel function of the target vehicle is activated.

It can be understood that, the historical running trajectory of the target vehicle on the commuting route may be stored in a local database or a cloud database for the target vehicle in order of acquisition time. Therefore, in the automatic drive, the recent historical running trajectory of the target vehicle on the commuting route can be acquired, based on which the target vehicle can be controlled to perform automatic drive on the commuting route. For example, if the driver manually performed an urgent brake every time when the target vehicle passed a certain segment of the commuting route in automatic drive in recent three days, the speed of the vehicle may be pre-reduced when the target vehicle is controlled to perform automatic drive on this segment of the commuting route. For example, the speed of the target vehicle is reduced from 60 km/h to 50 km/h, and then is gradually reduced to 40 km/h, 30 km/h and the like before the target vehicle arrives at the segment of the commuting route. The driving experience of the driver can be improved by pre-reducing the speed.

In summary, in the automatic driving method according to the embodiment of the present disclosure, it is determined whether a target vehicle travels on a pre-defined commuting route, where the commuting route is a fixed route on which the target vehicle travels at a frequency higher than a predetermined frequency threshold. Target travel information corresponding to the commuting route is acquired if the target vehicle travels on the pre-defined commuting route. The target travel information includes a historical running trajectory of the target vehicle on the commuting route. The target vehicle is controlled to perform automatic drive on the commuting route based on the target travel information. Therefore, with the embodiment of the present disclosure, the target vehicle, instead of being manually controlled by a driver to travel on the commuting route, can be controlled to perform automatic drive on the commuting route based on the acquired target travel information corresponding to the commuting route. Hence, repeated and tedious driving actions performed by the driver are reduced, thereby improving the driving experience of the driver.

In addition, only the target travel information corresponding to the commuting route, instead of the high-precision map with a large amount of data, needs to be stored in the local database of the target vehicle. In this case, the cost is reduced and the navigation accuracy is improved, while an actual requirement of driving on the commuting route is met.

It should be noted that, an implementation of step 101 of determining whether a target vehicle travels on a pre-defined commuting route” is described with the following steps 201 to 202 in the embodiment.

Reference is made to FIG. 2, which is a flowchart of an automatic driving method according to the embodiment. The automatic driving method includes steps 201 to 204.

In step 201, current position information of the target vehicle is acquired.

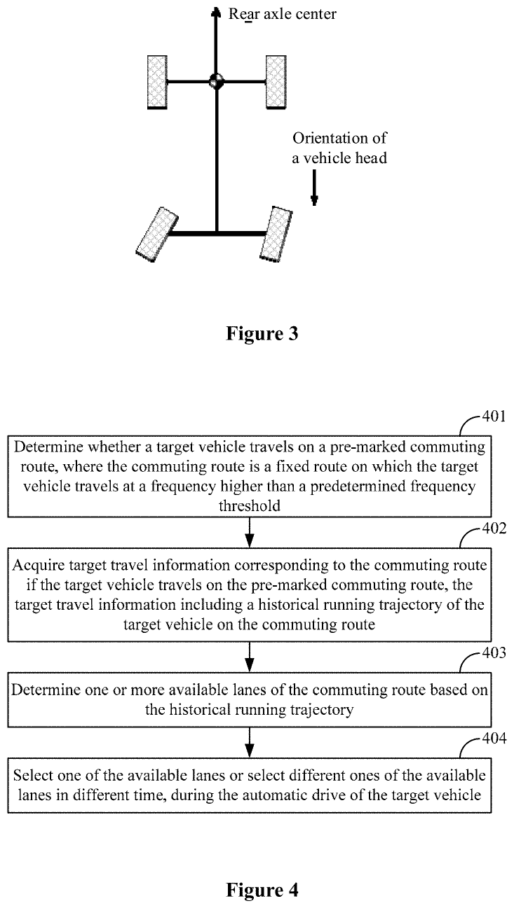

During the traveling of the target vehicle, a current position of the target vehicle can be acquired by using a positioning system. Changing coordinates of a rear axle center (as shown in FIG. 3) of the target vehicle may be acquired, or changing coordinates of other portions of the target vehicle may be acquired.

In an implementation of the embodiment, a geodetic coordinate of the target vehicle may be recorded as the position of the target vehicle. In the implementation, a satellite positioning system may be installed at a certain portion a of the target vehicle, and current longitude and latitude coordinates of the portion a is acquired with the satellite positioning system. Then, the longitude and latitude coordinates (i.e., geodetic coordinates) of the rear axle center of the target vehicle is calculated based on a relative position relationship between the portion a and the rear axle center of the vehicle, and the calculated longitude and latitude coordinates are taken as the current position information of the target vehicle.

In another implementation of the embodiment, local coordinates of the target vehicle may be recorded as the position of the target vehicle. In the implementation, a laser radar or a camera may be installed at a certain portion b of the target vehicle, and current local position coordinates of the portion b is acquired with a local positioning system based on the laser radar or the camera. Then, local coordinates of the rear axle center of the target vehicle is calculated based on a relative position relationship between the portion b and the rear axle center of the vehicle, and the calculated local coordinates are taken as the current position information of the target vehicle.

As can be seen, the current position information of the target vehicle can be acquired by the positioning system during the traveling of the vehicle. Then, step 202 may be performed.

In step 202, it is determined whether the target vehicle travels on the pre-defined commuting route based on the current position information and a forward direction of the target vehicle.

In practices, after the current position information of the target vehicle is acquired in step 201, whether the target vehicle travels on the pre-defined commuting router may be determined based on the current position information and the forward direction of the target vehicle.

Since a same road corresponds to two different commuting routes having different vehicle travel directions, and different commuting routes correspond to different defining results, the forward direction of the target vehicle is also required to determine whether the target vehicle travels on the pre-defined commuting route after the current position information of the target vehicle is acquired.

In step 203, if the target vehicle travels on the pre-defined commuting route, target travel information corresponding to the commuting route is acquired. The target travel information includes a historical running trajectory of the target vehicle on the commuting route.

In step 204, the target vehicle is controlled to perform automatic drive on the commuting route based on the target travel information.

It should be noted that, steps 203 to 204 are the same as steps 102 to 103 in the first embodiment. One may refer to the descriptions in the first embodiment for the related part, which is not repeated here.

In summary, in the automatic driving method according to the embodiment of the present disclosure, the current position information of the target vehicle may be acquired, and it is determined whether the target vehicle travels on the pre-defined commuting route based on the current position information and the forward direction of the target vehicle. The commuting route is a fixed route on which the target vehicle travels at a frequency higher than a predetermined frequency threshold. The target travel information corresponding to the commuting route is acquired if the target vehicle travels on the pre-defined commuting route. The target travel information includes a historical running trajectory of the target vehicle on the commuting route. The target vehicle is controlled to perform automatic drive on the commuting route based on the target travel information. Therefore, with the embodiment of the present disclosure, whether the target vehicle travels on the commuting route can be determined by acquiring the current position information and the forward direction of the target vehicle. In this way, the target vehicle can be controlled to perform automatic drive on the commuting route by using the target travel information corresponding to the commuting route. Hence, it is unnecessary for the driver to manually control the vehicle to travel on the commuting route, thereby reducing the repeated and tedious driving actions performed by the driver and improving the driving experience of the driver.

It should be noted that, an implementation of step 103 in the first embodiment is described with the following steps 403 to 404 in the embodiment.

Reference is made to FIG. 4, which is a flowchart of an automatic driving method according to the embodiment. The automatic driving method includes steps 401 to 404.

In step 401, it is determined whether a target vehicle travels on a pre-defined commuting route. The commuting route is a fixed route on which the target vehicle travels at a frequency higher than a predetermined frequency threshold.

In step 402, target travel information corresponding to the commuting route is acquired if the target vehicle travels on the pre-defined commuting route. The target travel information includes a historical running trajectory of the target vehicle on the commuting route.

It should be noted that, steps 401 to 402 are the same as steps 101 to 102 in the first embodiment, and one may refer to the description of the first embodiment for the related part, which is not repeated here. Apparently, step 401 may be replaced by steps 201 to 202 in the second embodiment or other implementations. One may refer to the description of the second embodiment for the related part, which is not repeated here.

In step 403, one or more available lanes of the commuting route are determined based on the historical running trajectory.

In an actual application, after the target travel information corresponding to the commuting route, that is, the historical running trajectory of the target vehicle on the commuting route, is acquired in step 402, one or more available lanes of the commuting route may be determined based on the historical running trajectory, and then step 404 can be performed.

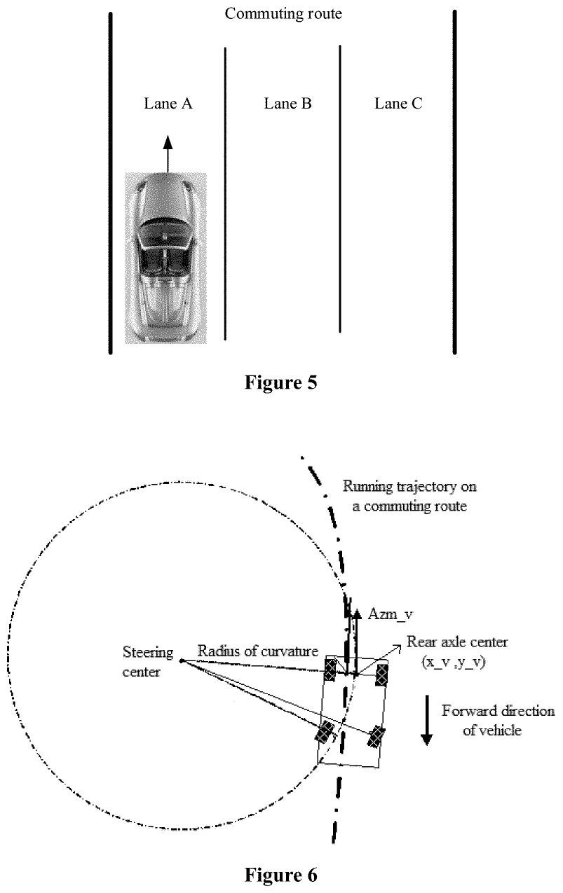

For example, as shown in FIG. 5 which is a schematic diagram of available lanes of a commuting route, there are totally three lanes in the commuting route, namely a lane A, a lane B and a lane C from left to right. If the historical running trajectory of the target vehicle on the commuting route acquired in step 402 includes that the target vehicle travelled on the lane A of the commuting route before, then the lane A of the commuting route may be determined as an available lane.

In step 404, one of the available lanes may be selected or different ones of the available lanes may be selected successively during the automatic drive of the target vehicle.

In practices, after the available lanes of the commuting route are determined in step 403, one of the available lanes may be selected, or different ones of the available lanes of the commuting route are selected successively, during the automatic drive of the target vehicle.

For example, based on the above example, still referring to FIG. 5, if the historical running trajectory of the target vehicle on the commuting route acquired in step 402 includes that, the target vehicle traveled on not only the lane A but also the lane B and lane C of the commuting route before, then all of the lanes A, B and C of the commuting route are determined as available lanes. Therefore, in the process of controlling the target vehicle to perform automatic drive, any one of the lanes A, B and C may be selected as an available lane for the automatic drive, or, different ones of the lanes A, B and C of the commuting route may be selected successively for the automatic drive. For example, the lane A may be first selected for the automatic drive, and the target vehicle may change to another lane after a period of time or when there is a vehicle in front of the target vehicle in the lane A. For example, the lane B is then selected for the automatic drive, or the target vehicle changes from the lane B to the lane C for the automatic drive.

In summary, in the automatic driving method according to the embodiment of the present disclosure, it is determined whether a target vehicle travels on a pre-defined commuting route, where the commuting route is a fixed route on which the target vehicle travels at a frequency higher than a predetermined frequency threshold. Target travel information corresponding to the commuting route is acquired if the target vehicle travels on the pre-defined commuting route. The target travel information includes a historical running trajectory of the target vehicle on the commuting route. One or more available lanes of the commuting route are determined based on the historical running trajectory. One of the available lanes is selected or different ones of the available lanes are selected successively, during the automatic drive of the target vehicle. Therefore, with the embodiment of the present disclosure, the target vehicle can be controlled to perform automatic drive by automatically selecting one lane of the commuting route or changing between the available lanes of the commuting route.

It should be noted that, in the embodiment, in addition to the historical running trajectory of the target vehicle on the commuting route, the above target travel information corresponding to the commuting route may further include at least one of: running state information of the target vehicle in the historical running trajectory, and information on a control behavior performed by the driver on the target vehicle in the historical running trajectory.

The running state information of the target vehicle in the historical running trajectory may be state information of the target vehicle at position points of the historical running trajectory, such as information of longitude x_v, latitude y_v, speed, steering wheel angle and heading Azm_v at each position point, as shown in FIG. 6. The information on a control behavior performed by the driver on the target vehicle in the historical running trajectory may be information of controls on the speed, the steering wheel angle, and the like performed by the driver when the target vehicle travels in the historical running trajectory.

In addition, the above running state information and control behavior information may be used to construct a vehicle dynamical model, which may be used to control the automatic drive of the target vehicle each time.

Based on the above, an implementation of step 103 in the first embodiment is described with the following steps 703 to 704 in the embodiment.

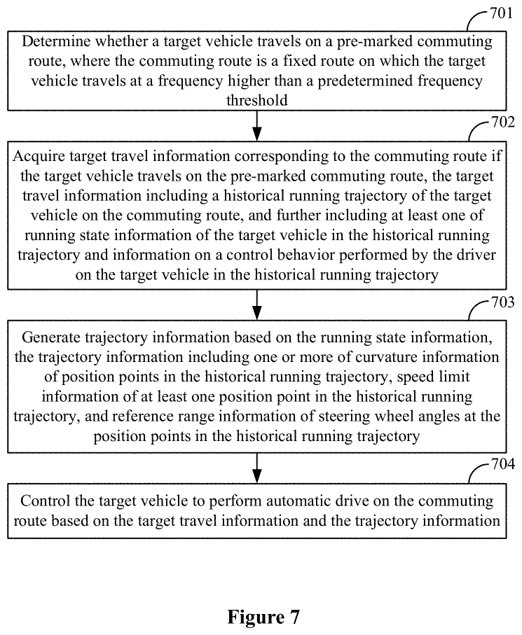

Reference is made to FIG. 7, which is a flowchart of an automatic driving method according to the embodiment. The automatic driving method includes steps 701 to 704.

In step 701, it is determined whether a target vehicle travels on a pre-defined commuting route, where the commuting route is a fixed route on which the target vehicle travels at a frequency higher than a predetermined frequency threshold.

It should be noted that, step 701 is the same as step 101 in the first embodiment. One may refer to the descriptions in the first embodiment for the related part, which is not repeated here. Apparently, step 701 may be replaced by steps 201 to 202 in the second embodiment or other implementations. One may refer to the descriptions in the second embodiment for the related part, which is not repeated here.

In step 702, target travel information corresponding to the commuting route is acquired if the target vehicle travels on the pre-defined commuting route.

The target travel information includes a historical running trajectory of the target vehicle on the commuting route, and at least one of running state information of the target vehicle in the historical running trajectory and information on a control behavior performed by the driver on the target vehicle in the historical running trajectory.

It should be noted that, the method for acquiring the target travel information corresponding to the commuting route in step 702 is the same as that in step 102 in the first embodiment. One may refer to the descriptions in the first embodiment for the related part, which is not repeated here. The method for acquiring the at least one of the running state information of the target vehicle in the historical running trajectory and the information on a control behavior performed by the driver on the target vehicle in the historical running trajectory in step 702 is the same as that in step 201 in the second embodiment. One may refer to the descriptions in the second embodiment for the related part, which is not repeated here. In another embodiment, the at least one of the running state information of the target vehicle in the historical running trajectory and the information on a control behavior performed by the driver on the target vehicle in the historical running trajectory may be obtained from the vehicle dynamical model.

In step 703, trajectory information is generated based on the running state information.

In the embodiment, the target travel information corresponding to the commuting route may be acquired in step 702. The target travel information includes the running state information of the target vehicle in the historical running trajectory. Hence, trajectory information can be generated based on the running state information. The trajectory information includes one or more of: curvature information of position points in the historical running trajectory (i.e., a curvature of a certain position point in the historical running trajectory), speed limit information of at least one position point in the historical running trajectory, and reference range information of steering wheel angles at the position points in the historical running trajectory.

The speed limit information of at least one position point in the historical running trajectory indicates that the speed of the target vehicle is limited in at least one position point on the commuting route. For example, in a previous driving, if the driver performed braking for multiple times in a certain travel section, a speed limit value may be set for the travel section based on a speed-reducing extent of the target vehicle. For example, the speed is limited to 60 km/h. The reference range information of the steering wheel angles at the position points in the historical running trajectory indicates reference ranges of the steering wheel angles at the position points for the current automatic drive calculated based on the historical running trajectory generated when the target vehicle ran on the commuting route in the past.

In step 704, the target vehicle is controlled to perform automatic drive on the commuting route based on the target travel information and the trajectory information.

In the embodiment, after the trajectory information is acquired in step 703, the target vehicle may be controlled to perform automatic drive on the commuting route based on the target travel information and the trajectory information.

For example, in the current automatic driving, if it is determined that the driver performed an urgent brake for multiple times when the target vehicle passed a certain position with a speed limit of 40 km/h on the commuting route, based on the trajectory information, the speed of the vehicle may be pre-reduced when the target vehicle controlled to perform automatic drive is close to this speed limit position of the commuting route. That is, the speed of the vehicle is gradually reduced when the vehicle is in a certain distance from this speed limit position. For example, the speed of the target vehicle is first reduced from 70 km/h to 60 km/h, then reduced to 50 km/h, and is reduced to 40 km/h or less when the vehicle arrives at the speed limit position. The driving experience of the driver can be improved by gradually pre-reducing the speed.

For another example, in the current automatic driving, under the condition that the reference range information of the steering wheel angle corresponding to the current position point is determined based on the trajectory information, if a steering wheel angle actually decided at a current position point is not in the reference range, it indicates that the decision is incorrect and the steering wheel angle should be modified to be in the reference range.

In summary, in the automatic driving method according to the embodiment of the present disclosure, it is determined whether a target vehicle travels on a pre-defined commuting route, where the commuting route is a fixed route on which the target vehicle travels at a frequency higher than a predetermined frequency threshold. Target travel information corresponding to the commuting route is acquired if the target vehicle travels on the pre-defined commuting route. The target travel information includes a historical running trajectory of the target vehicle on the commuting route, and further includes at least one of running state information of the target vehicle in the historical running trajectory and information on a control behavior performed by the driver on the target vehicle in the historical running trajectory. Trajectory information is generated based on the running state information. The trajectory information includes one or more of: curvature information of position points in the historical running trajectory, speed limit information of at least one position point in the historical running trajectory, and reference range information of steering wheel angles at the position points in the historical running trajectory. Then, the target vehicle is controlled to perform automatic drive on the commuting route based on the target travel information and the trajectory information. Therefore, with the embodiment of the present disclosure, the target vehicle can be controlled to perform automatic drive on the commuting route based on the acquired target travel information corresponding to the commuting route and the trajectory information. In this case, it is unnecessary for the driver to manually control the vehicle to travel on the commuting route, thereby reducing the repeated and tedious driving actions performed by the driver and improving the driving experience of the driver.

In the above embodiments, the commuting route may be defined with a defining method according to the embodiment, which includes the following two implementations.

In a first implementation, the commuting route may be defined by steps A to C.

In step A, vehicle position information of the target vehicle is recorded at recording time points during a process that the target vehicle travels from a target start point to a target end point. The target start point is an origin set for the commuting route by a driver, and the target end point is a destination set for the commuting route by the driver.

In step B, a running trajectory of the target vehicle is formed with the recorded vehicle position information.

In step C, a road consistent with the running trajectory is defined as the commuting route.

In the implementation, if the driver wants to define a commuting route, he may manually set an origin position and a destination position of the commuting route. Here, the origin position is defined as the target start point and the destination position is defined as the target end point. In the setting process, the origin position may be set as the target start point when the target vehicle is located at the origin position, and the destination position is set as the target end point after being searched in a map or after the target vehicle arrives the destination position. Therefore, the commuting route may be recorded when the target vehicle travels on the commuting route for the first time. In order to record the commuting route, the automatic driving function of the target vehicle may be inactivated, and the target vehicle is manually driven by the driver to travel on the commuting route. In this process, the target vehicle is controlled to record the commuting route in a teaching and programming manner. Meanwhile, vehicle position information of the target vehicle at recording time points is recorded, to form a running trajectory of the target vehicle between the target start point and the target end point. Then, a road consistent with the running trajectory may be defined as a commuting route. In this way, the process of defining the commuting route is completed.

In an implementation, the recording the vehicle position information of the target vehicle at the recording time points in step A includes: recording geodetic coordinates of the target vehicle at the recording time points, or recording local coordinates of the target vehicle at the recording time points.

In a process that the target vehicle travels from the target start point to the target end portion, a position of the target vehicle may be continuously acquired by using a positioning system at a preset time interval (such as 0.5 seconds). The changing coordinates of a rear axle center (as shown in FIG. 3) of the target vehicle may be acquired, the or changing coordinates of other portions of the target vehicle may be acquired.

In an implementation of the embodiment, the position of the target vehicle may be recorded as geodetic coordinates of the target vehicle. In the implementation, a satellite positioning system may be installed at a certain portion a of the target vehicle, and the longitude and latitude coordinates of the portion a are acquired with the satellite positioning system. Then, the longitude and latitude coordinates (i.e., geodetic coordinates) of the rear axle center of the target vehicle is calculated based on a relative position relationship between the portion a and the rear axle center of the vehicle, and the calculated longitude and latitude coordinates are taken as the position of the target vehicle.

In another implementation of the embodiment, the position of the target vehicle may be recorded as a local coordinate of the target vehicle. In the implementation, a laser radar or a camera may be installed at a certain portion b of the target vehicle, and a local position coordinate of the portion b is acquired with a local positioning system based on the laser radar or the camera. Then, a local coordinate of the rear axle center of the target vehicle is calculated based on a relative position relationship between the portion b and the rear axle center of the vehicle, and the calculated local coordinate is taken as the position information of the target vehicle.

As can be seen, in a process that the target vehicle travels from the target start point to the target end point, the position of the target vehicle, that is, a position coordinate of the target vehicle at a certain time point, is acquired with the positioning system. In this case, a series of coordinate points from the target start point to the target end point may be recorded as the vehicle moves. The time may be divided into several time segments, and a smoothing process may be performed on coordinate points in each of the time segments to form a running trajectory of the target vehicle, and then a road consistent with the running trajectory is defined as a commuting route.

In a second implementation, the commuting route may be defined by steps D to G

In step D, vehicle position information of the target vehicle is recorded at recording time points during a running of the target vehicle.

In step E, a running trajectory of the target vehicle is formed with the recorded vehicle position information.

In step F, it is determined whether the number of times that the target vehicle runs on a road consistent with the running trajectory exceeds a preset threshold within a preset period of time.

In step G, the road is defined as the commuting route if the number of times that the target vehicle runs on the road consistent with the running trajectory within the preset period of time exceeds the preset threshold.

In the implementation, in a running process of the target vehicle (may be a manual driving process without using the automatic driving function, or an automatic driving process under the navigation of a high-precision map), the vehicle position information of the target vehicle at the respective recording time points are recorded. In an implementation, the recorded vehicle position information of the target vehicle at the recording time points may be geodetic coordinates of the target vehicle at the recording time points, or local coordinates of the target vehicle at the recording time points. A process of recording the vehicle position information of the target vehicle at the recording time points is the same as that in the first implementation. One may refer to the descriptions in the first implementation for the related part, which is not repeated here.

By the step E, the running trajectory of the target vehicle can be formed by using the vehicle position information of the target vehicle recorded at the recording time points. A process of forming the running trajectory is similar to that in the first implementation. One may refer to the descriptions in the first implementation for the related part, which is not repeated here.

Then, a road consistent with the running trajectory may be determined based on the running trajectory acquired in step E. Moreover, it may be determined whether the number of times that the target vehicle travels on the road exceeds a preset threshold within a preset period of time. The preset period of time and the preset threshold are both set in advance for determining whether a road is a commuting route. For example, the preset period of time may be set as ten days and the preset threshold is set as ten times. In this case, it is determined whether the number of times that the target vehicle travels on the road exceeds ten times within ten days. The road is defined as a commuting route if the number of times that the target vehicle travels on the road exceeds ten times within ten days, and otherwise the road is not defined as a commuting route.

It should be noted that, the above preset period of time and the preset threshold may be set as needed, which is not limited herein.

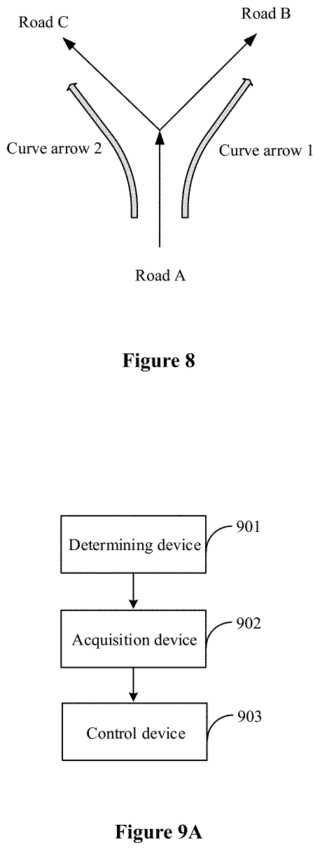

It should be also noted that, in practices, the commuting route may be re-defined based on a recent running trajectory of the vehicle. Reference is made to FIG. 8, which shows a schematic diagram of a commuting route re-defining according to an embodiment of the present disclosure. As shown in FIG. 8, if a road A and a road B are defined as a commuting route, that is, the historical running trajectory of the target vehicle is along a direction indicated by a curve arrow 1 in FIG. 8, from the road A to the road B. However, in recent days, for example, in recent 10 days, the running trajectory of the target vehicle is changed to a direction indicated by a curve arrow 2 in FIG. 8, i.e., from the road A to the road C. In this case, the commuting route may be re-defined based on the change in the running trajectory of the target vehicle, that is, the commuting route originally defined as the road A and the road B is changed to the road A to the road C, thereby improving the accuracy in defining the commuting route.

Therefore, two methods for defining the commuting rout are provided according to the embodiment, so as to determine whether the target vehicle travels on the pre-defined commuting route in the case that the automatic driving function of the target vehicle is activated, thereby achieving a subsequent automatic driving.

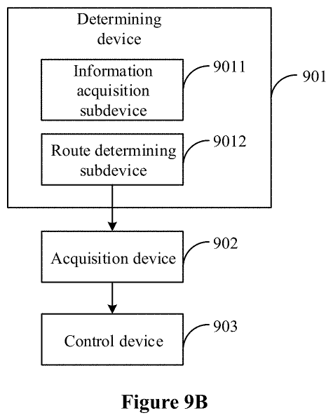

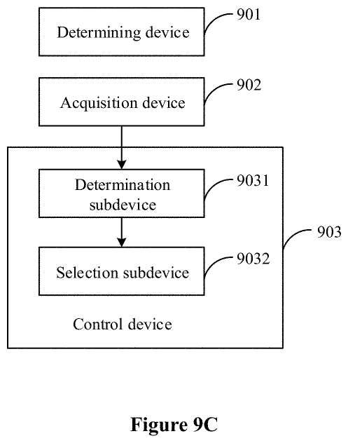

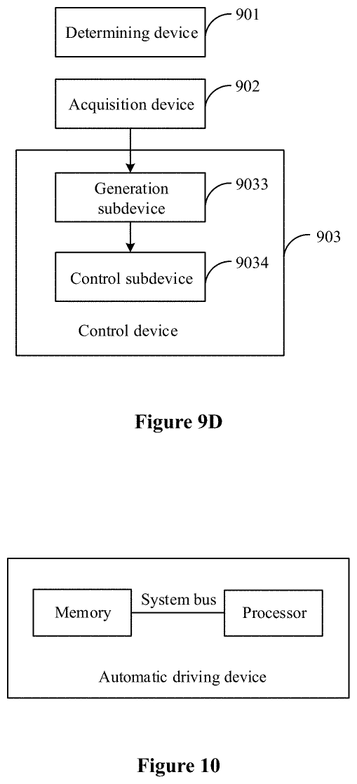

Reference is made to FIG. 9A, which is a block diagram of an automatic driving device according to the embodiment. The automatic driving device includes a determining device 901, an acquisition device 902 and a control device 903.

The determining device 901 is configured to determine whether a target vehicle travels on a pre-defined commuting route, where the commuting route is a fixed route on which the target vehicle travels at a frequency higher than a predetermined frequency threshold.

The acquisition device 902 is configured to acquire target travel information corresponding to the commuting route if the target vehicle travels on the pre-defined commuting route. The target travel information includes a historical running trajectory of the target vehicle on the commuting route.

The control device 903 is configured to control the target vehicle to perform automatic drive on the commuting route based on the target travel information.

In an implementation of the embodiment, as shown in FIG. 9B, the determining device 901 may include an information acquisition subdevice 9011 and a route determining subdevice 9012.

The information acquisition subdevice 9011 is configured to acquire current position information of the target vehicle.

The route determining subdevice 9012 is configured to determine whether the target vehicle travels on the pre-defined commuting route based on the current position information and a forward direction of the target vehicle.

In an implementation of the embodiment, as shown in FIG. 9C, the control device 903 may include a determination subdevice 9031 and a selection subdevice 9032.

The determination subdevice 9031 is configured to determine one or more available lanes of the commuting route based on the historical running trajectory.

The selection subdevice 9032 is configured to select one of the available lanes or select different ones of the available lanes successively, during the automatic drive of the target vehicle.

In an implementation of the embodiment, the target travel information further includes at least one of: running state information of the target vehicle in the historical running trajectory; and information on a control behavior performed by the driver on the target vehicle in the historical running trajectory.

In an implementation of the embodiment, as shown in FIG. 9D, the control device 903 may include a generation subdevice 9033 and a control subdevice 9034.

The generation subdevice 9033 is configured to generate trajectory information based on the running state information, where the trajectory information includes one or more of: curvature information of position points in the historical running trajectory, speed limit information of at least one position point in the historical running trajectory, and reference range information of steering wheel angles at the position points in the historical running trajectory.

The control subdevice 9034 is configured to control the target vehicle to perform automatic drive on the commuting route based on the target travel information and the trajectory information.

In an implementation of the embodiment, the device further includes a recording device, a forming device and a defining device.

The recording device is configured to record vehicle position information of the target vehicle at recording time points during a process that the target vehicle travels from a target start point to a target end point, where the target start point is an origin set for the commuting route by a driver, and the target end point is a destination set for the commuting route by the driver.

The forming device is configured to form a running trajectory of the target vehicle with the recorded vehicle position information.

The defining device is configured to define a road consistent with the running trajectory as the commuting route.

In an implementation of the embodiment, the device further includes a recording device, a forming device, a determining device and a defining device.

The recording device is configured to record vehicle position information of the target vehicle at the recording time points during a running of the target vehicle.

The forming device is configured to form a running trajectory of the target vehicle with the recorded vehicle position information.

The determining device is configured to determine whether the number of times that the target vehicle runs on a road consistent with the running trajectory exceeds a preset threshold within a preset period of time.

The defining device is configured to define the road as the commuting route if the number of times that the target vehicle runs on the road consistent with the running trajectory within the preset period of time exceeds the preset threshold.

In an implementation of the embodiment, the recording device is configured to record geodetic coordinates of the target vehicle at the recording time points; or record local coordinates of the target vehicle at the recording time points.

Further, an automatic driving device is provided according to an embodiment of the present disclosure. The automatic driving device includes a processor, a memory and a system bus, as shown in FIG. 10.

The processor and the memory are connected to each other via the system bus.

The memory is configured to store one or more programs including instructions. The instructions, when executed by the processor, cause the processer to perform the above automatic driving method according to any one of the above embodiments.

Further, a computer readable storage medium is further provided according to an embodiment of the present disclosure. The computer readable storage medium stores instructions. The instructions, when running on a terminal device, cause the terminal device to perform the above automatic driving method according to any one of the above embodiments.

Further, a computer program product is further provided according to an embodiment of the present disclosure. The computer program product, when running on a terminal device, causes the terminal device to perform the above automatic driving method according to any one of the above embodiments.

As can be seen from the above embodiments, all or a part of steps in the methods according to the above embodiments may be implemented by means of software and necessary general hardware platform. Base on such understanding, the essential part of the technical solution of the present disclosure or the part of the technical solution of the present disclosure contributed to the conventional technology may be embodied as a software product.

The computer software product is stored in a storage medium, such as an ROM/RAM, a magnetic disk and an optical disk, which includes several instructions to make a computer device (may be a personal computer, a server, a network communication device such as a media gateway, or the like) execute the methods according to the embodiments or some parts of the embodiments of the present disclosure.

It should be noted that, the embodiments in this specification are described in a progressive way, each of which emphasizes the differences from others, and for the same or similar parts, the embodiments can be referred to each other. Since the device embodiments correspond to the method embodiments, the description thereof is relatively simple, and for relevant matters references may be made to the description of the method.

It should be further noted that the relationship terminologies such as “first”, “second” and the like are only used herein to distinguish one entity or operation from another, rather than to necessitate or imply that the actual relationship or order exists between the entities or operations. Furthermore, terms of “include”, “comprise” or any other variants are intended to be non-exclusive. Therefore, a process, method, article or device including multiple elements includes not only the elements but also other elements that are not enumerated, or also include the elements inherent to the process, method, article or device. Unless expressively limited otherwise, the statement “comprising (including) a . . . ” does not exclude the case that other similar elements may exist in the process, method, article or device.

1. An automatic driving method, comprising:
determining whether a target vehicle travels on a pre-defined commuting route, wherein the commuting route is a fixed route on which the target vehicle travels at a frequency higher than a predetermined frequency threshold;
acquiring target travel information corresponding to the commuting route if the target vehicle travels on the pre-defined commuting route, wherein the target travel information comprises a historical running trajectory of the target vehicle on the commuting route; and
controlling the target vehicle to perform automatic drive on the commuting route based on the target travel information.

2. The automatic driving method according to claim 1, wherein the determining whether a target vehicle travels on a pre-defined commuting route comprises:
acquiring current position information of the target vehicle; and
determining whether the target vehicle travels on the pre-defined commuting route based on the current position information and a forward direction of the target vehicle.

3. The automatic driving method according to claim 1, wherein the controlling the target vehicle to perform automatic drive on the commuting route based on the target travel information comprises:
determining one or more available lanes of the commuting route based on the historical running trajectory; and
selecting one of the available lanes or selecting different ones of the available lanes successively, during the automatic drive of the target vehicle.

4. The automatic driving method according to claim 1, wherein the target travel information further comprises at least one of:
running state information of the target vehicle in the historical running trajectory; and
information on a control behavior performed by the driver on the target vehicle in the historical running trajectory.

5. The automatic driving method according to claim 1, wherein the target travel information comprises running state information of the target vehicle in the historical running trajectory, and the controlling the target vehicle to perform automatic drive on the commuting route based on the target travel information comprises:
generating trajectory information based on the running state information, wherein the trajectory information comprises one or more of: curvature information of position points in the historical running trajectory, speed limit information of at least one position point in the historical running trajectory, and reference range information of steering wheel angles at the position points in the historical running trajectory; and
controlling the target vehicle to perform automatic drive on the commuting route based on the target travel information and the trajectory information.

6. The automatic driving method according to claim 1, further comprising: defining the commuting route, wherein the defining the commuting route comprises:
recording vehicle position information of the target vehicle at recording time points during a process that the target vehicle travels from a target start point to a target end point, wherein the target start point is an origin set for the commuting route by a driver, and the target end point is a destination set for the commuting route by the driver;
forming a running trajectory of the target vehicle with the recorded vehicle position information; and
defining a road consistent with the running trajectory as the commuting route.

7. The automatic driving method according to claim 1, further comprising: defining the commuting route, wherein the defining the commuting route comprises:
recording vehicle position information of the target vehicle at recording time points during a running of the target vehicle;
forming a running trajectory of the target vehicle with the recorded vehicle position information;
determining whether the number of times that the target vehicle runs on a road consistent with the running trajectory exceeds a preset threshold within a preset period of time; and
defining the road as the commuting route if the number of times that the target vehicle runs on the road consistent with the running trajectory exceeds the preset threshold within the preset period of time.

8. The automatic driving method according to claim 6, wherein the recording vehicle position information of the target vehicle at recording time points comprises:
recording geodetic coordinates of the target vehicle at the recording time points; or recording local coordinates of the target vehicle at the recording time points.

9. An automatic driving device, comprising:
a processor,
a memory for storing program instructions, and
a system bus, wherein the processor and the memory are connected via the system bus, and wherein the processor is configured to execute the program instructions to:
determine whether a target vehicle travels on a pre-defined commuting route, wherein the commuting route is a fixed route on which the target vehicle travels at a frequency higher than a predetermined frequency threshold;
acquire target travel information corresponding to the commuting route if the target vehicle travels on the pre-defined commuting route, wherein the target travel information comprises a historical running trajectory of the target vehicle on the commuting route; and
control the target vehicle to perform automatic drive on the commuting route based on the target travel information.

10. The automatic driving device according to claim 9, wherein the processor is configured to execute the program instructions further to:
acquire current position information of the target vehicle; and
determine whether the target vehicle travels on the pre-defined commuting route based on the current position information and a forward direction of the target vehicle.

11. The automatic driving device according to claim 9, wherein the processor is configured to execute the program instructions further to:
determine one or more available lanes of the commuting route based on the historical running trajectory; and
select one of the available lanes or select different ones of the available lanes successively, during the automatic drive of the target vehicle.

12. The automatic driving device according to claim 9, wherein the target travel information further comprises at least one of:
running state information of the target vehicle in the historical running trajectory; and
information on a control behavior performed by the driver on the target vehicle in the historical running trajectory.

13. The automatic driving device according to claim 9, wherein the target travel information comprises running state information of the target vehicle in the historical running trajectory, and the processor is configured to execute the program instructions further to:
generate trajectory information based on the running state information, wherein the trajectory information comprises one or more of: curvature information of position points in the historical running trajectory, speed limit information of at least one position point in the historical running trajectory, and reference range information of steering wheel angles at the position points in the historical running trajectory; and
control the target vehicle to perform automatic drive on the commuting route based on the target travel information and the trajectory information.

14. The automatic driving device according to claim 9, wherein the processor is configured to execute the program instructions further to:
record vehicle position information of the target vehicle at recording time points during a process that the target vehicle travels from a target start point to a target end point, wherein the target start point is an origin set for the commuting route by a driver, and the target end point is a destination set for the commuting route by the driver;
form a running trajectory of the target vehicle with the recorded vehicle position information; and
define a road consistent with the running trajectory as the commuting route.

15. The automatic driving device according to claim 9, wherein the processor is configured to execute the program instructions further to:
record vehicle position information of the target vehicle at recording time points during a running of the target vehicle;
form a running trajectory of the target vehicle with the recorded vehicle position information;
determine whether the number of times that the target vehicle runs on a road consistent with the running trajectory exceeds a preset threshold within a preset period of time; and
define the road as the commuting route if the number of times that the target vehicle runs on the road consistent with the running trajectory exceeds the preset threshold within the preset period of time.

16. The automatic driving device according to claim 14, wherein the processor is configured to execute the program instructions further to:
record geodetic coordinates of the target vehicle at the recording time points; or
record local coordinates of the target vehicle at the recording time points.

17. A computer readable storage medium storing instructions, wherein the instructions, when running on a terminal device, cause the terminal device to:
determine whether a target vehicle travels on a pre-defined commuting route, wherein the commuting route is a fixed route on which the target vehicle travels at a frequency higher than a predetermined frequency threshold;
acquire target travel information corresponding to the commuting route if the target vehicle travels on the pre-defined commuting route, wherein the target travel information comprises a historical running trajectory of the target vehicle on the commuting route; and
control the target vehicle to perform automatic drive on the commuting route based on the target travel information.

18. A computer program product, wherein the computer program product, when running on a terminal device, causes the terminal device to perform the method according to claim 1.
